(19) United States
(12) Patent Application Publication
(10) Pub. No.: US 2008/0176531 A1
(43) Pub. Date: Jul. 24, 2008

(54) WIRELESS COMMUNCATION SYSTEM AND CHARGE CONTROL METHOD

(76) Inventor: KENICHI KOMATSU, Tokyo (JP)

Correspondence Address: NEC CORPORATION OF AMERICA, 6535 N. STATE HWY 161, IRVING, TX, 75039, US

(21) Appl. No.: 11/960,032

(22) Filed: Dec. 19, 2007

(30) Foreign Application Priority Data
Jan. 18, 2007 (JP) 2007-009099

(51) Int. Cl. H04M 15/00

(52) U.S. Cl. 455/406

(57) ABSTRACT

When a wireless line between a spot base station device and a wireless communication terminal is connected, a charging device starts charging according to a charging plan set for the spot base station device instead of according to a charging plan uniformly set by a carrier so that the charging plan can be independent for each spot area covered by the spot base station device.

This application is based upon and claims the benefit of priority from Japanese patent application No. 2007-009099, filed on Jan. 11, 2007, the disclosure of which is incorporated herein in its entirety by reference.

### BACKGROUND OF THE INVENTION

1. Field of the Invention

The present invention relates to a wireless communication system including an indoor spot base station device.

2. Description of the Related Art

A wireless communication system that includes an outdoor macro-base station device and an indoor spot base station device charges for use of a cellular phone terminal provided by a carrier at a predetermined fixed time-based measured rate or a flat rate whether the cellular phone terminal is connected with the outdoor macro-base station device or the indoor spot base station device. The outdoor macro-base station device is a base station included in a wide wireless area (hereinafter referred to as “macro area”). The outdoor macro-base station devices are distributed in a region controlled by the carrier. The indoor spot base station device is included in a wireless area (hereinafter referred to as “spot area”) that is further included in the wireless area of the outdoor macro-base station device. The indoor spot base station device is provided in an area with high traffic such as a station or a building that is open for the public.

A cellular phone terminal usually connects with the outdoor macro-base station device via a wireless line. When the cellular phone terminal enters in the spot area of the indoor spot base station device, the cellular phone terminal connects with the indoor spot base station device via the wireless line and disconnects from the outdoor macro-base station device. The invention disclosed in Japanese Unexamined Patent Application Publication No. 7-250371 lowers the traffic sent out from the cellular phone terminal to the outdoor macro-base station device by using the above-mentioned technique.

The indoor spot base station device may be provided in various places as mentioned above and may be privately provided by an entity other than a carrier. Therefore, flexible billing systems have been preferably employed for respective areas such that an indoor spot base station device provided in a place for students charges at a student rate.

However, the rates charged by the wireless communication system have been previously fixed by the carrier. Thus, the wireless communication system can not charge for use of the cellular phone terminals independently for each spot area for the indoor spot base station device.

### SUMMARY OF THE INVENTION

An exemplary object of the present invention is to provide a wireless communication system and a charge control method that enables independent charging for the use of cellular phone terminals in each spot area covered by the indoor spot base station device.

In order to achieve the above object, the wireless communication system according to an exemplary aspect of the invention is a wireless communication system that enables a wireless communication terminal to perform data communication in a spot area independent of a macro area covered by a carrier, wherein the wireless communication terminal subscribes to a service provided by the carrier, comprising: a spot base station device that covers the spot area with a wireless line and enables the wireless communication terminal to perform data communication by connecting with the wireless communication terminal in the spot area; and a charging device that charges for use of the wireless communication terminal according to a charging plan set for the spot area when the spot base station device and the wireless communication terminal are connected with each other.

The charge control method according to the an exemplary aspect of the invention is a charge control method employed in a wireless communication system that enables a wireless communication terminal to perform data communication via a spot base station device in a spot area independent of a macro area covered by a carrier, wherein the wireless communication terminal is subscribing to a service provided by the carrier, wherein a wireless line provided by the spot base station device covers the spot area, and when the spot base station device connects with the wireless communication terminal in the spot area and the spot base station device and the wireless communication terminal are connected with each other, the charge for use of the wireless communication terminal is made according to a charging plan set for the spot area.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a schematic view showing the configuration of a wireless communication system in an exemplary embodiment;

FIG. 2 is a flowchart showing processing performed by the wireless communication system in the exemplary embodiment;

FIG. 3 is a sequence chart showing the processing performed by the wireless communication system in the exemplary embodiment;

FIG. 4 is a sequence chart showing processing performed by the wireless communication system due to time out;

FIG. 5 is a sequence chart showing a case where the destination of cellular phone terminal 1 that has moved outside a spot area of indoor spot base station device 3 is switched;

FIG. 6 is a block diagram showing the configuration of cellular phone terminal 1 in the exemplary embodiment;

FIG. 7 is a block diagram showing the configuration of indoor spot base station device 3 in the exemplary embodiment;

FIG. 8 is a block diagram showing the configuration of charging device 4 in the exemplary embodiment;

FIG. 9 is a flowchart showing the processing performed by the wireless communication system due to time out; and

FIG. 10 is a flowchart showing a case where the destination of cellular phone terminal 1 that has moved outside the spot area of the indoor spot base station device 3 is switched.

### DETAILED DESCRIPTION OF THE PREFERRED EMBODIMENTS

An exemplary embodiment for implementing the present invention will be described in detail with reference to the drawings.

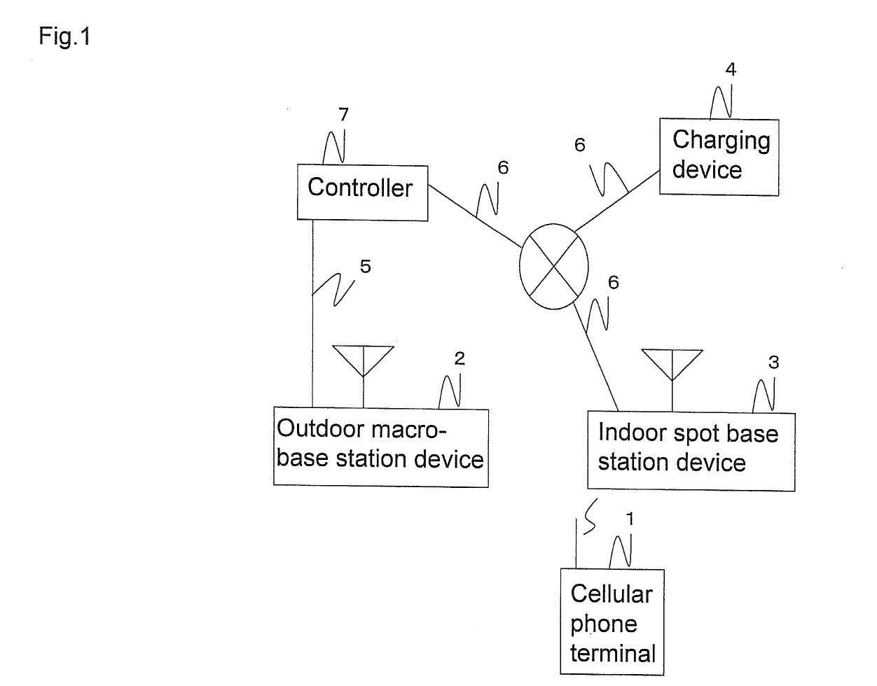

FIG. 1 is a schematic view showing the configuration of a wireless communication system in an exemplary embodiment. The wireless communication system includes cellular phone terminal 1, outdoor macro-base station device 2, indoor spot base station device 3, charging device 4 and controller 7.

Cellular phone terminal 1 can connect with outdoor macro-base station device 2 of a carrier as well as private indoor spot base station device 3 via a wireless line. When cellular phone terminal 1 connects with outdoor macro-base station device 2, cellular phone terminal 1 becomes capable of data communication via outdoor macro-base station device 2. When cellular phone terminal 1 connects with indoor spot base station device 3, cellular phone terminal 1 becomes capable of data communication via indoor spot base station device 3.

Cellular phone terminal 1 stores user information. Cellular phone terminal 1 includes a prepaid function for paying the bill for data communication via indoor spot base station device 3. The user information includes name, phone number, mail-address, and credit card number. The prepaid function is for paying a charge to be billed when cellular phone terminal 1 connects with indoor spot base station device 3 in advance. User information is used in the prepaid process. When cellular phone terminal 1 stores the credit card number, that credit card number is used in the prepaid process.

Outdoor macro-base station device 2 is connected with controller 7 via line 5 and can be connected to cellular phone terminal 1 via a wireless line in a macro area. When outdoor macro-base station device 2 is connected with cellular phone terminal 1 via a wireless line, it becomes capable of sending out data to cellular phone terminal 1 at a communication rate of up to 14 Mbps by using the communication system W-CDMA (Wideband-Code Division Multiple Access).

Indoor spot base station device 3 is connected with controller 7 and charging device 4 via Internet 6 and can connect with cellular phone terminal 1 via a wireless line in a spot area. When indoor spot base station device 3 is authorized by charging device 4 to establish wireless line connection, indoor spot base station device 3 connects with cellular phone terminal 1 via the wireless line and becomes capable of sending out data to cellular phone terminal 1 at a communication rate of up to 100 Mbps by using the communication system OFDM (Orthogonal Frequency Division Multiplexing).

Charging device 4 manages the amount of money previously paid by a user (hereinafter referred to as ‘prepaid amount’). Charging device 4 is connected with indoor spot base station device 3 via Internet 6 and is also connected with controller 7. Charging device 4 authorizes indoor spot base station device 3 to establish wireless line connection based on the prepaid amount. When a line between indoor spot base station device 3, which is authorized to establish wireless line connection, and cellular phone terminal 1 is connected, charging device 4 starts charging for use of cellular phone terminal 1 according to its own charging plan that is different from that of the carrier's. When the line between indoor spot base station device 3 and cellular phone terminal 1 is disconnected, charging device 4 stops the billing and stores the balance.

Controller 7 is connected with outdoor macro-base station device 2 via line 5 and with indoor spot base station device 3 and charging device 4 via Internet 6. Controller 7 controls switching destination of cellular phone terminal 1 from outdoor macro-base station device 2 to indoor spot base station device 3 or from indoor spot base station device 3 to outdoor macro-base station device 2 according to the determination based on the prepaid amount charged by charging device 4.

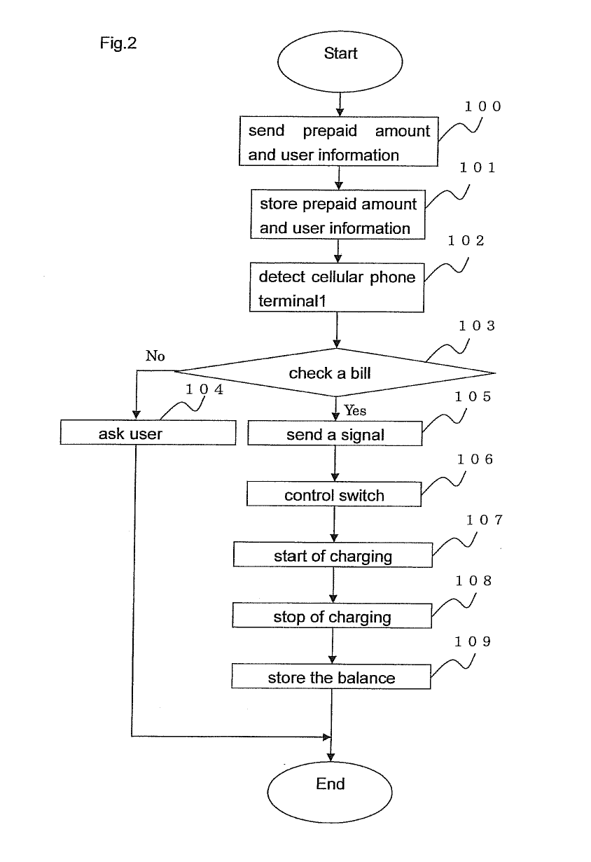

Now, processing performed by the wireless communication system in the exemplary embodiment will be described in detail with reference to FIG. 1 and FIG. 2. The processing to be described here includes two processes of a prepaid process and a process that charges for use of cellular phone terminal 1 after the prepaid process.

First, processing performed by the wireless communication system in the prepaid process will be described.

Cellular phone terminal 1 sends the prepaid amount and user information to charging device 4 via outdoor macro-base station device 2 and controller 7 (step 100). When charging device 4 receives the prepaid amount and the user information from cellular phone terminal 1, charging device 4 stores the prepaid amount and the user information (step 101).

Now, processing performed by the wireless communication system for charging for use of cellular phone terminal 1 after the prepaid process is completed will be described.

When indoor spot base station device 3 detects cellular phone terminal 1 in a predetermined range, it reads the user information from cellular phone terminal 1 and sends the user information to charging device 4 (step 102). Charging device 4 checks whether or not a bill has been paid previously based on the user information sent from indoor spot base station 2 and the user information that it stores (step 103). If no bill has been paid previously, charging device 4 asks the user to pay the bill (step 104).

If a bill has been paid previously, charging device 4 authorizes indoor spot base station device 3 to establish the wireless line connection and sends a signal for switching the destination of the line (hereinafter referred to ‘line switching signal’) to controller 7 (step 105). When controller 7 receives the line switching signal from charging device 4, it controls switching the destination of cellular phone terminal 1 from outdoor macro-base station device 2 to indoor spot base station device 3 (step 106). When a line between indoor spot base station device 3 and cellular phone terminal 1 is connected, charging device 4 starts charging for use of cellular phone terminal 1 according to its own charging plan that is different from that of the carrier's (step 107). When the line between indoor spot base station device 3 and cellular phone terminal 1 is disconnected, charging device 4 stops charging (step 108). Charging device 4 stores the balance (step 109).

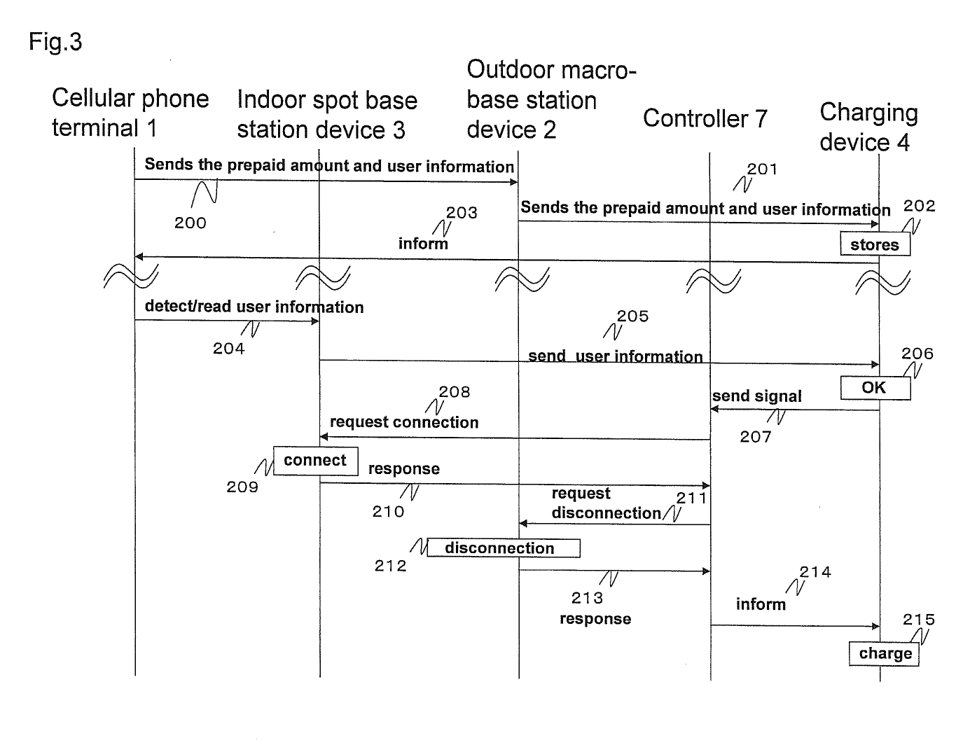

FIG. 3 is a sequence chart showing the charging process performed by the wireless communication system in the exemplary embodiment.

First, processing performed by the wireless communication system in the prepaid process will be described.

Cellular phone terminal 1 sends the prepaid amount and the user information to outdoor macro-base station device 2 (step 200). When outdoor macro-base station device 2 receives the prepaid amount and the user information from cellular phone terminal device 1, it sends them to charging device 4 via controller 7 (step 201). When charging device 4 receives the prepaid amount and the user information sent from outdoor macro-base station device 2, charging device 4 stores the prepaid amount and the user information (step 202). When charging device 4 stores the prepaid amount and the user information, charging device 4 informs cellular phone terminal 1 that the prepaid payment has been made (step 203).

Now, processing performed by the wireless communication system to start charging for use of cellular phone terminal 1 after the prepaid process is completed will be described.

When indoor spot base station device 3 detects cellular phone terminal 1 in a predetermined range, indoor spot base station device 3 reads the user information stored in cellular phone terminal 1 (step 204). Indoor spot base station device 3 sends the read user information to charging device 4 (step 205). Charging device 4 checks the account based on user information sent from indoor spot base station 2 and the user information charging device 4 stores. If there is any remaining prepaid amount, charging device 4 authorizes the controller 7 to establish the wireless line connection (step 206). When charging device 4 authorizes the controller 7 to establish the wireless line connection, charging device 4 sends the line switching signal to controller 7 (step 207).

When controller 7 receives the line switching signal from charging device 4, controller 7 asks indoor spot base station device 3 to connect the line (step 208). When indoor spot base station device 3 is asked to connect the line by controller 7, indoor spot base station device 3 connects the line with cellular phone terminal 1 (step 209).

When indoor spot base station device 3 has connected the line with cellular phone terminal 1, indoor spot base station device 3 informs controller 7 that it has connected the line (step 210). When controller 7 is informed that the line has been connected by indoor spot base station device 3, controller 7 asks outdoor macro-base station device 2 to disconnect the line (step 211).

When outdoor macro-base station device 2 is asked by controller 7 to disconnect the line, outdoor macro-base station device 2 disconnects the line with cellular phone terminal 1 (step 212). When outdoor macro-base station device 2 has disconnected the line with cellular phone terminal 1, outdoor macro-base station device 2 informs controller 7 that outdoor macro-base station device 2 has disconnected the line (step 213).

When controller 7 is informed by outdoor macro-base station device 2 that the line has been disconnected, controller 7 informs charging device 4 that the line has been switched (step 214). When charging device 4 is informed that the line has been switched by controller 7, charging device 4 starts charging for use of cellular phone terminal 1 (step 215).

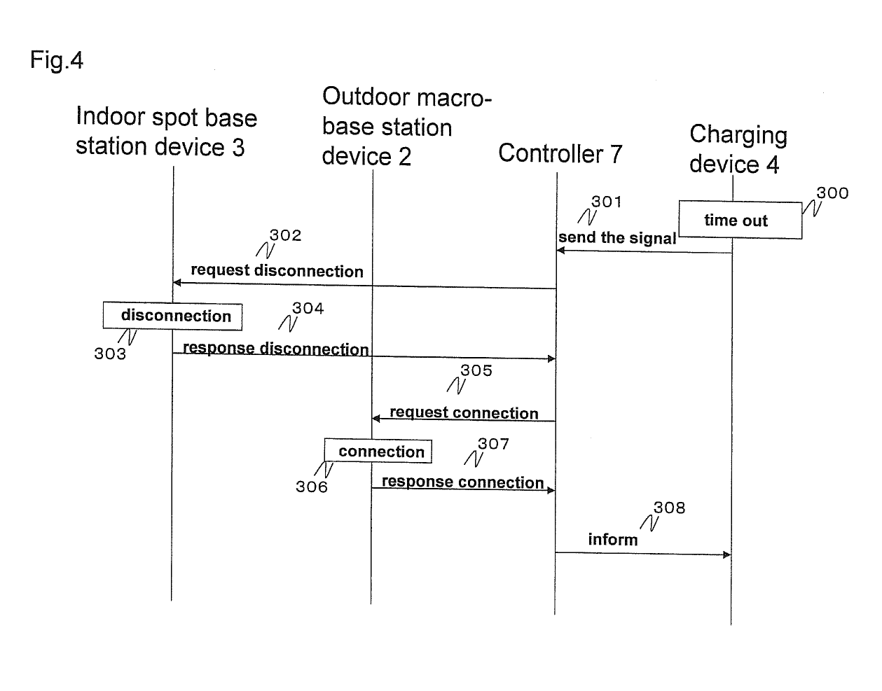

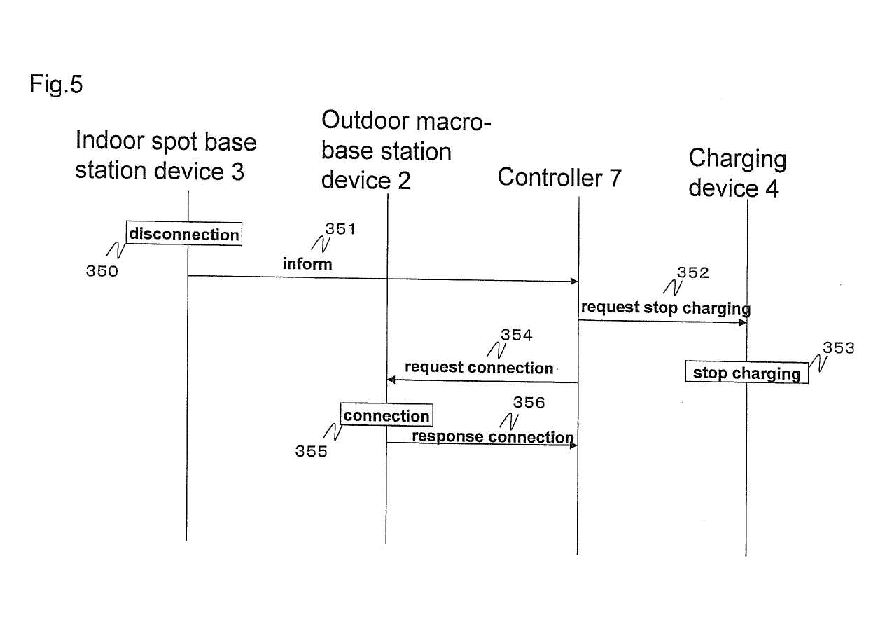

Now, processing performed by the wireless communication system to switch the destination of cellular phone terminal 1 from indoor spot base station device 3 to outdoor macro-base station device 2 with reference to FIG. 4 and FIG. 5 will be described.

FIG. 4 is a sequence chart showing processing performed by the wireless communication system due to time out. Time out is the situation in which the amount that has been charged by charging device 4 to cellular phone terminal 1 reaches the prepaid amount. Charging device 4 has recorded the prepaid amount and has started charging for use of cellular phone terminal 1 based on the prepaid amount by itself.

When the time out occurs (step 300), charging device 4 sends the line switching signal to controller 7 (step 301). When controller 7 receives the line switching device from charging device 4, controller 7 asks indoor spot base station device 3 to disconnect the line (step 302).

When indoor spot base station device 3 is asked by controller 7 to disconnect the line, indoor spot base station device 3 disconnects the line (step 303). When the line with cellular phone terminal 1 has been disconnected, indoor spot base station device 3 informs controller 7 that the line has been disconnected (step 304). When controller 7 is informed that the line has been disconnected by indoor spot base station device 3, controller 7 asks outdoor macro-base station device 2 to connect the line (step 305).

When outdoor macro-base station device 2 is asked by controller 7 to connect the line, it connects the line with cellular phone terminal 1 (step 306). When outdoor macro-base station device 2 connects the line with cellular phone terminal 1, outdoor macro-base station device 2 informs controller 7 that it has connected the line (step 307).

When controller 7 is informed that the line has been connected by outdoor macro-base station device 2, controller 7 informs charging device 4 that it has switched the destination (step 308).

FIG. 5 is a sequence chart showing a case where the destination of cellular phone terminal 1 that has moved outside a spot area covered by indoor spot base station device 3 is switched. FIG. 5 shows a case where a user who owns cellular phone terminal 1 moves out from the spot area covered by indoor spot base station device 3. Charging device 4 has recorded the prepaid amount and has started charging for use of cellular phone terminal 1 based on the prepaid amount by itself.

When cellular phone terminal 1 moves outside the spot area covered by indoor spot base station device 3, indoor spot base station device 3 disconnects the line (step 350). When indoor spot base station device 3 has disconnected the line, indoor spot base station device 3 informs controller 7 that the line has been disconnected (step 351). When controller 7 is informed that the line has been disconnected by indoor spot base station device 3, controller 7 asks charging device 4 to stop the charging (step 352). Charging device 4 stops charging (step 353).

Controller 7 asks outdoor macro-base station device 2 to connect the line (step 354). When outdoor macro-base station device 2 is asked to connect the line by controller 7, outdoor macro-base station device 2 connects the line with cellular phone terminal 1 (step 355). When outdoor macro-base station device 2 has connected with cellular phone terminal 1, outdoor macro-base station device 2 informs controller 7 that it has connected the line (step 356).

Although the exemplary embodiment has shown a case where, when cellular phone terminal 1 moves outside the spot area covered by indoor spot base station device 3, indoor spot base station device 3 disconnects the line, the present invention is not limited to the case. For example, the present invention may be adapted such that indoor spot base station device 3 disconnects the line after a predetermined period after cellular phone terminal 1 moves outside the spot area. That can prevent a situation in which cellular phone terminal 1 near the boundary of the spot area causes charging device 4 to frequently start and stop charging. Therefore, that can reduce the load of charging device 4.

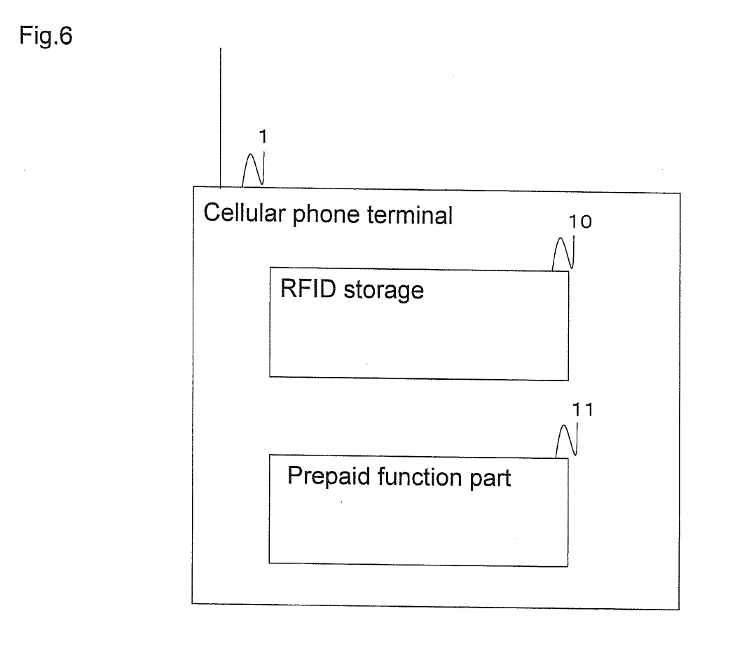

FIG. 6 is a block diagram showing the configuration of cellular phone terminal 1 in the exemplary embodiment. Cellular phone terminal 1 includes RFID (Radio Frequency Identification) storage 10 and prepaid function part 11.

RFID storage 10 records the user information.

Prepaid function part 11 causes the amount of money, which is charged for use of cellular phone terminal 1 due to establishment of the connection to indoor spot base station device 3, to be prepaid. When the user makes the prepayment, prepaid function part 11 sends the prepaid amount and the user information recorded in RFID storage 10 to charging device 4 via outdoor macro-base station device 2 and controller 7. If the user information recorded in RFID storage 10 includes the credit card number, prepaid function part 11 makes payment in advance by using the credit card number.

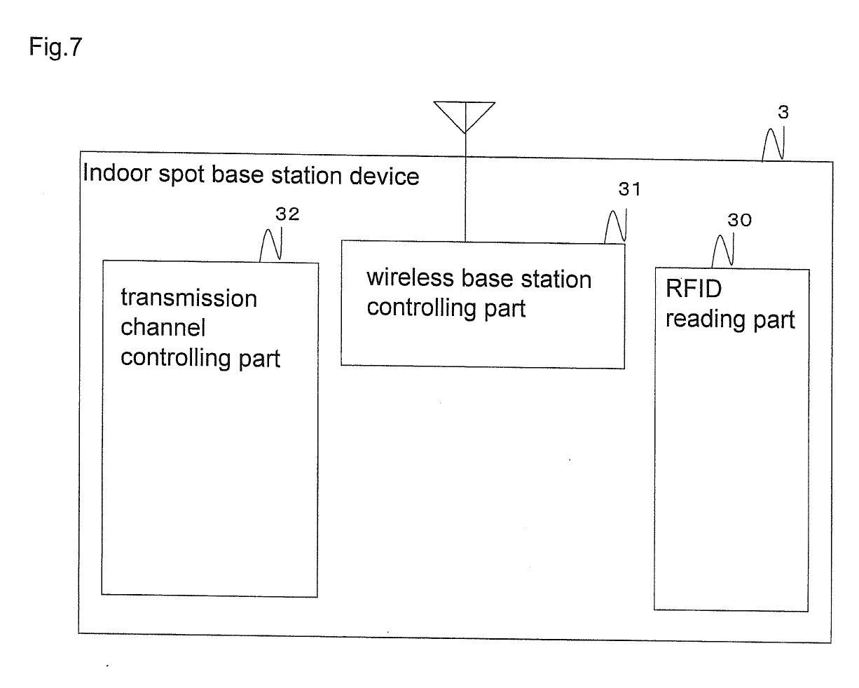

FIG. 7 is a block diagram showing the configuration of indoor spot base station device 3 in the exemplary embodiment. Indoor spot base station device 3 has RFID reading part 30, wireless base station controlling part 31 and transmission channel controlling part 32.

When cellular phone terminal 1 approaches the region in which RFID reading part 30 can read the information from cellular phone terminal 1, RFID reading part 30 reads the user information recorded in RFID storage 10. RFID reading part 30 sends the read user information to transmission channel controlling part 32.

Wireless base station controlling part 31 controls connection and disconnection of the line between outdoor macro-base station device 2 or indoor spot base station device 3 and cellular phone terminal 1. When wireless base station controlling part 31 is informed by transmission channel controlling part 32 to connect or disconnect the line, it connects or disconnects the line with outdoor macro-base station device 2 or indoor spot base station device 3 according to the information.

Wireless base station controlling part 31 can switch QoS (Quality of Service) control and the wireless system according to the situation that the amount has been charged by charging device 4 to cellular phone terminal 1. In the W-CDMA communication system, wireless base station controlling part 31 can speed up the communication rate by switching the current modulating system to another one such as the 16 QAM (Quadrature Amplitude Modulation) or by switching the current communication system to another one such as the OFDM. That enables the quality of service for cellular phone terminal 1 and the throughput toward cellular phone terminal 1 to depend on the prepaid amount so that the user who paid lot is allowed to receive high quality QoS service.

When transmission channel controlling part 32 receives the user information sent from RFID reading part 30, transmission channel controlling part 32 sends the user information to charging device 4. When transmission channel controlling part 32 receives the user information and the prepaid amount from wireless base station controlling part 31, transmission channel controlling part 32 sends the user information and the prepaid amount to charging device 4. When transmission channel controlling part 32 is asked to connect or disconnect the line by controller 7, transmission channel controlling part 32 informs wireless base station controlling part 31 to connect or to disconnect the line.

Accordingly, indoor spot base station device 3 sends the read user information to the charging device via Internet 6. That can reduce the load of communication network 5.

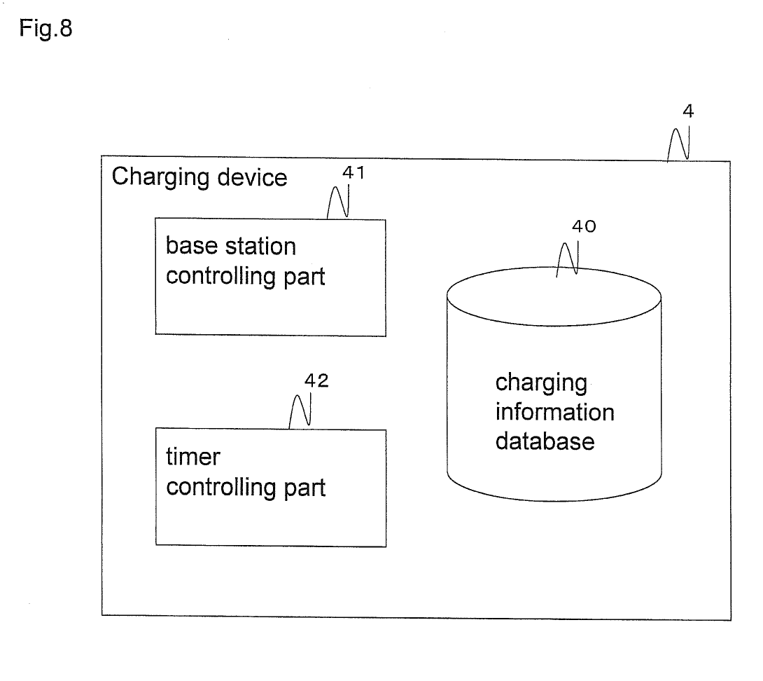

FIG. 8 is a block diagram showing the configuration of charging device 4 in the exemplary embodiment. Charging device 4 includes charging information database 40, base station controlling part 41, and timer controlling part 42.

Charging information database 40 associates the user information and prepaid amount with each other and stores the user information and prepaid amount.

When base station controlling part 41 receives the user information and prepaid amount from prepaid function part 11, base station controlling part 41 causes the user information and prepaid amount of money associated with the user information to be stored in charging information database 40. Base station controlling part 41 checks the account of cellular phone terminal 1 associated with the user information recorded in charging information database 40 by comparing the user information sent from transmission channel controlling part 32 and the user information recorded in charging information database 40. If there is any remaining the prepaid amount, base station controlling part 41 authorizes connection of the line. When base station controlling part 41 is informed by controller 7 that the destination has been switched, base station controlling part 41 causes timer controlling part 42 to start the timer.

Due to the request from base station controlling part 41, timer controlling part 42 increments the timer by a certain amount of time. Timer controlling part 42 has set an initial value of the timer to zero and increments the timer starting at the initial value of zero until the value reaches that allowed for the remaining prepaid amount.

Although a case where timer controlling part 42 increments the timer by a certain amount of time is described in the exemplary embodiment, the present invention is not limited to that. Timer controlling part 42 may decrement the timer by a certain amount of time, for example. In such a case, timer controlling part 42 sets the initial value base on the remaining prepaid amount and decrements the timer starting at the set initial value.

The time period for incremented or decremented timer may be changed according to the prepaid amount. According to that plan, timer controlling part 42 increments or decrements the timer by one minute or more based on the relationship between the prepaid amount and the predetermined amount, and increments or decrements the timer by 30 seconds base subtracting the predetermined amount from the prepaid amount.

Accordingly, a user who paid more is allowed to receive the wireless service of indoor spot base station device 3 for a longer time.

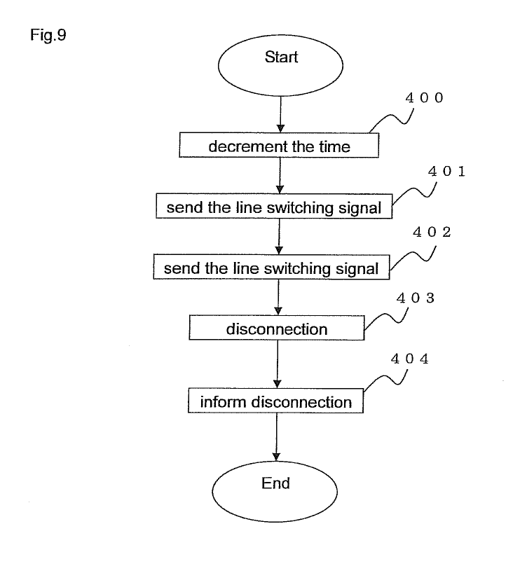

FIG. 9 is a flowchart showing processing performed by the wireless communication system due to time out. Charging device 4 has recorded the user information and a predetermined amount of money. In FIG. 9, charging device 4 has recorded a prepaid amount and starts charging for use of cellular phone terminal 1 based on prepaid amount by itself.

Timer controlling part 42 of charging device 4 decrements the timer by a certain amount of time (step 400). When the value of the timer reaches a predetermined value, for example zero, base station controlling part 41 sends the line switching signal to controller 7 to disconnect the line with indoor macro-base station device 2 (step 401).

When controller 7 receives the line switching signal from base station controlling part 41 of charging device 4, controller 7 asks transmission channel controlling part 32 of indoor spot base station device 3 to disconnect the line (step 402). When transmission channel controlling part 32 is asked to disconnect the line by base station controlling part 41 via controller 7, it disconnects the line with cellular phone terminal 1 (step 403). Transmission channel controlling part 32 informs controller 7 that the line has been disconnected (step 404).

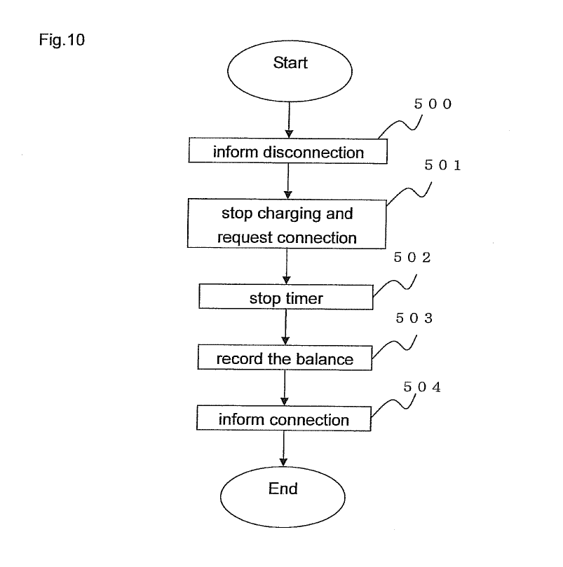

FIG. 10 is a flowchart showing a case where the destination of cellular phone terminal 1 that has moved outside the spot area covered by indoor spot base station device 3 is switched. FIG. 10 shows a case where a user who owns cellular phone terminal 1 moves from inside to outside of the spot area. Charging device 4 has recorded the prepaid amount and starts charging for use of cellular phone terminal 1 based on the recorded prepaid amount by itself.

When cellular phone terminal 1 moves from inside to outside of the spot area covered by indoor spot base station device 3, wireless base station controlling part 31 of indoor spot base station device 3 informs controller 7 that the line has been disconnected (step 500). When controller 7 is informed by wireless base station controlling part 31 that the line has been disconnected, controller 7 asks base station controlling part 41 of charging device 4 to stop the charging and also asks outdoor macro-base station device 2 to connect the line (step 501).

When base station controlling part 41 is asked to stop the charging by controller 7, base station controlling part 41 stops the timer of timer controlling part 42 (step 502). Base station controlling part 41 calculates the balance based on the value of the timer and records the balance in charging information database 40 (step 503).

When outdoor macro-base station device 2 is asked to connect the line by controller 7, it connects with cellular phone terminal 1 and informs controller 7 that the line has been connected (step 504).

As mentioned above, according to the exemplary embodiment, when the wireless line between indoor spot base station device 3 and cellular phone terminal 1 is connected, charging device 4 starts charging according to the plan set for indoor spot base station device 3 instead according to of the plan uniformly set by the carrier so that the charging plan can be independent for each wireless area covered by indoor spot base station device 3.

Although the exemplary embodiment has been described by a case where the charging device is connected with the controller and the indoor spot base station device via the Internet, the present invention is not limited to that. The charging device may be adapted to interconnect with a charging system such as the Felica (Registered Trademark) or the Edy. In such a case, payment made for purchase via the Felica or the Edy is stored in the charging device. Then, the purchaser is allowed to use the wireless service based on the stored amount of money. According to the system, the wireless service can be limitedly provided for the purchaser.

Although the exemplary embodiment has been described by a case where the amount of money charged due to establishment of the connection with indoor spot base station device is prepaid, the present invention is not limited to that. Alternatively, the charging device may charge the amount of money afterward, which is the amount that will be charged due to establishing the connection with the indoor spot base station device.

The present invention can be applied to a user inside a private spot area such as an internet café.

According to the present invention, when a wireless line between the spot base station device and the wireless communication terminal is connected, the charging device starts charging according to the plan set for the spot base station device instead of according to the plan uniformly set by the carrier so that the charging plan can be independent for each spot area covered by the spot base station device.

The charging device may change the amount of money charged for a predetermined period according to the amount previously paid by the wireless communication terminal.

Accordingly, the user who paid more is allowed to receive the wireless service of the spot base station device for a longer time.

The spot base station device may change the communication rate toward the wireless communication terminal according to the amount previously paid by the wireless communication terminal.

With that plan, the quality of service for the wireless communication terminal and the throughput toward the wireless communication terminal depends on the amount of money previously paid so that the user who paid a lot is allowed to receive high quality QoS service.

While preferred embodiments of the present invention have been described using specific terms, such description is for illustrative purposes only, and it is to be understood that changes and variations may be made without departing from the spirit or scope of the following claims.

What is claimed:

1. A wireless communication system that enables a wireless communication terminal to perform data communication in a spot area independent of a macro area covered by a carrier, wherein the wireless communication terminal is subscribing to a service provided by said carrier, the wireless communication system comprising:
a spot base station device that covers said spot area with a wireless line and enables the wireless communication terminal to perform data communication by connecting with said wireless communication terminal in said spot area; and
a charging device that charges for use of said wireless communication terminal according to a charging plan set for said spot area when said spot base station device and said wireless communication terminal are connected with each other.

2. The wireless communication system according to claim 1, wherein
said wireless communication terminal has previously stored user information for identifying a user and has a function for previously paying a charge due to establishment of the connection with said spot base station device, wherein when the user makes previous payment, said wireless communication terminal sends said user information and the prepaid amount to said charging device; and
when said charging device receives said user information and said prepaid amount from said wireless communication terminal, said charging device stores said received user information and said prepaid amount, having them associated with each other; and when said spot base station device and said wireless communication terminal are connected with each other, said charging device subtracts the charge for data communication from said prepaid amount.

3. The wireless communication system according to claim 2, wherein
said wireless communication terminal records said user information so that said spot base station device can read the user information;
said spot base station device can read the user information recorded in said wireless communication terminal in said spot area, and when said spot base station device reads said user information from said wireless communication terminal, said spot base station device sends said read user information to said charging device; and
when said charging device receives the user information from said spot base station device and there is a remaining prepaid amount that corresponds to the user information, said charging device authorizes establishing the connection between said spot base station device and said wireless communication terminal.

4. The wireless communication system according to claim 3, wherein when said charging device authorizes said spot base station device to connect with said wireless communication terminal, said spot base station device connects the wireless line with said wireless communication terminal cellular phone terminal.

5. The wireless communication system according to claim 3, wherein
when said charging device receives said user information from said spot base station device, said charging device checks said prepaid amount associated with said user information based on said user information from said spot base station device and said recorded user information; and if there is any said prepaid amount that remain said charging device connection with said spot base station device via said wireless line; and when said authorized wireless line between said spot base station device and said wireless communication terminal is established, said charging device charges for use of said wireless communication terminal.

6. The wireless communication system according to claim 2, wherein said charging device changes the amount to charge for a predetermined period according to the amount previously paid by said wireless communication terminal.

7. The wireless communication system according to claim 2, wherein said spot base station device changes the communication rate toward said wireless communication terminal according to the amount previously paid by said wireless communication terminal.

8. A charge control method employed in a wireless communication system that enables a wireless communication terminal to perform data communication via a spot base station device in a spot area independent of a macro area covered by a carrier, wherein the wireless communication terminal is subscribing to a service provided by said carrier, wherein
a wireless line provided by said spot base station device covers said spot area and said wireless communication terminal in said spot area is connected via said spot base station device; and
when said spot base station device and said wireless communication terminal are connected with each other, use of said wireless communication terminal is charged according to a charging plan set for said spot area.

9. The charge control method according to claim 8, wherein
said wireless communication terminal has previously stored user information for identifying a user and has a function for previously paying a charge due to establishment of the connection with said spot base station device, wherein when the user makes previous payment, said wireless communication terminal sends said user information and the prepaid amount to said charging device for charging the amount of money charged for use of said spot base station device; and
when said charging device receives said user information and said prepaid amount from said wireless communication terminal, said charging device stores said received user information and said prepaid amount associated with each other; and when said spot base station device and said wireless communication terminal are connected with each other, said charging device subtracts a charge for data communication from said prepaid amount.

10. The charge control method according to claim 9, wherein
said wireless communication terminal records said user information so that said spot base station device can read the user information;
said spot base station device can read the user information recorded in said wireless communication terminal in said spot area, and when said spot base station device reads said user information from said wireless communication terminal, said spot base station device sends said read user information to said charging device; and
when said charging device receives the user information from said spot base station device and there is a remaining prepaid amount that corresponds to the user information, said charging device authorizes establishing the connection between said spot base station device and said wireless communication terminal.

11. The charge control method according to claim 10, wherein when said charging device authorizes said spot base station device to connect with said wireless communication terminal, said spot base station device connects the wireless line with said wireless communication terminal.

12. The charge control method according to claim 10, wherein
when said charging device receives said user information from said spot base station device, said charging device checks said prepaid amount associated with said user information based on said user information from said spot base station device and said recorded user information; and if there is any said prepaid amount is that remains, said charging device authorizes the wireless communication terminal corresponding to said user information to establish connection with said spot base station device via said wireless line; and when said authorized wireless line between said spot base station device and said wireless communication terminal is established, said charging device charges for use of said wireless communication terminal.

13. The charge control method according to claim 9, wherein said charging device changes the amount to charge for a predetermined period according to the amount previously paid by said wireless communication terminal.

14. The charge control method according to claim 9, wherein said spot base station device changes the communication rate toward said wireless communication terminal according to the amount previously paid by said wireless communication terminal.

15. A wireless communication system that enables a wireless communication terminal to perform data communication in a spot area independent of a macro area covered by a carrier, wherein the wireless communication terminal is subscribing to a service provided by said carrier, the wireless communication system comprising:
a spot base station means that covers said spot area with a wireless line and that enables the wireless communication terminal to perform data communication by connecting with said wireless communication terminal in said spot area; and
a charging means that charges for use of said wireless communication terminal according to a charging plan set for said spot area when said spot base station device and said wireless communication terminal are connected with each other.
